(19) United States
(12) Patent Application Publication
(10) Pub. No.: US 2006/0171415 A1
(43) Pub. Date: Aug. 3, 2006

(54) Electronic system for vehicles and a method for reducing the electromagnetic interference on electronic systems in vehicles

(75) Inventors: Christian Hauser, Gottmadingen (DE); Joachim Beck, Randegg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/330,844

(22) Filed: Jan. 12, 2006

(30) Foreign Application Priority Data
Jan. 13, 2005 (DE) 102005001711.8

(51) Int. Cl. H04J 3/24; H04B 3/54; B60L 1/00; H04J 3/00; H04J 4/00; G08B 1/08

(52) U.S. Cl. 370/473; 370/476; 370/478; 307/1; 307/10.1; 340/538.11

(57) ABSTRACT

The invention provides an electronic system for vehicles. The electronic system comprises an electronic control unit 10a, peripheral units 12b, 12c, and a communication line 20. The communication line 20 connects the electronic control unit 10a with the peripheral units 12b or 12c. Discrete successive digital data packets are exchanged between the control unit 10a and the peripheral unit 12b or 12c via the communication line. The electronic system is configured so as to vary the duration a₁, a₂, . . . , aₘ of the data packets and/or the duration T_{x,1}, T_{x,2}, . . . , T_{x,n} of the information bits contained in the appertaining data packet aₓ, thereby reducing electromagnetic interference.

The present invention relates to a method for reducing the effect of electromagnetic radiation (interference) on electronic systems in vehicles as well as to an electronic system comprising an electronic control unit, peripheral units and a communication line. The communication line connects the electronic control unit to the peripheral units. The electronic control unit is configured to exchange data with the peripheral units.

Electronic systems of the above-mentioned type are used especially in the realm of motor vehicle electronics. Such an electronic system is used, for example, to control restraint systems. The peripheral units employed in such cases are especially sensors that continuously detect the acceleration of the vehicle. A control unit is provided that is connected to the acceleration sensors and to corresponding actors for the restraint system.

The electronic system described above for controlling a restraint system in a motor vehicle is a typical example. Normally, modern motor vehicles have a number of such electronic systems that are used for a wide array of purposes. Each of the various electronic systems also constitutes a transmitter and a receiver of electromagnetic radiation. By the same token, the communication lines of the electronic systems also function as antennas. The electronic components and the communication lines are normally shielded against electromagnetic radiated interference. Individual electronic components can be shielded against electromagnetic radiation by being installed in HF-proof housings. The greater the radiated interference, the greater the effort needed to shield against electromagnetic radiated interference.

The basic idea of the present invention is to reduce the effect of the unavoidable electromagnetic radiation. Malfunctions in electronic systems occur to a greater extent when the amplitude of the electromagnetic radiated interference exceeds some threshold.

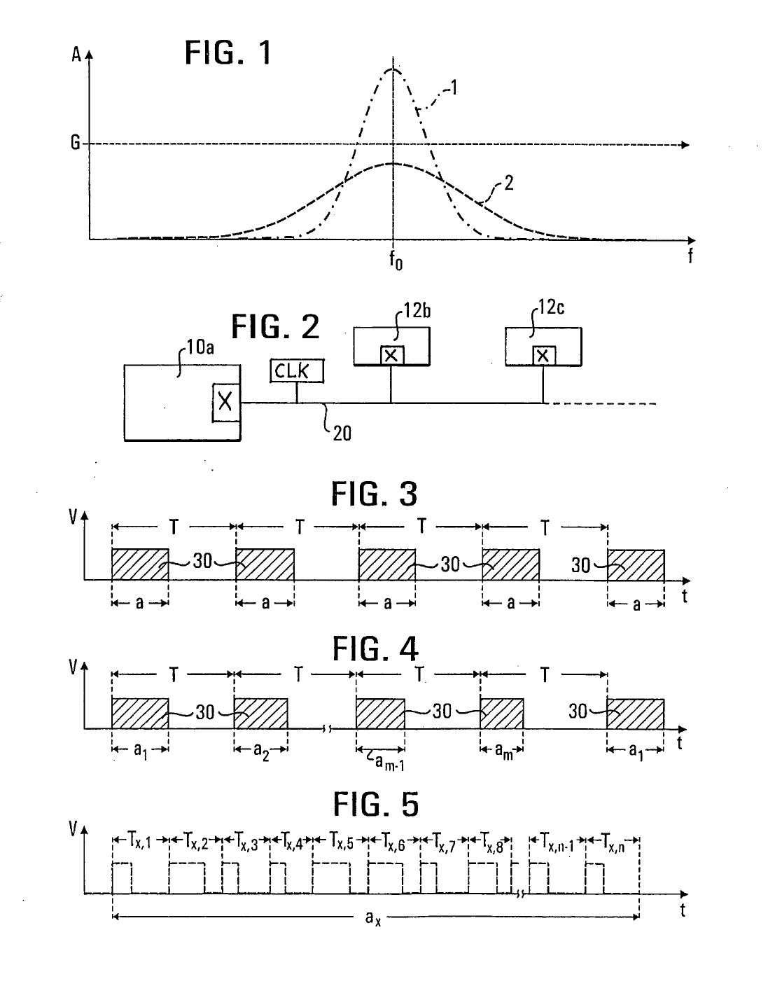

With reference to the appending drawings, curve 1 in FIG. 1 shows the amplitude spectrum of the electromagnetic radiation that is generated by a conventional electronic system, while curve 2 shows the spectrum generated by the electronic system according to the invention. Moreover, a threshold value G is plotted in FIG. 1. Both curves 1 and 2 constitute distributions whose maximum lies in the range of a frequency f₀. The maximum of curve 1, however, exceeds the threshold value G, whereas the maximum of curve 2 lies below the threshold value G. Consequently, the electronic components are less interfered with by the radiation.

In conventional electronic systems, the data is transmitted in discrete successive digital data packets between the control unit and the connected peripheral units at regular intervals. In each of the consecutive periods T, one data packet is transmitted between a peripheral unit and the electronic control unit. When data packets having the same length are transmitted, the current flowing through the communication line is essentially a periodic function. It is a known phenomenon that a periodic function has a discrete amplitude spectrum. In actual fact, however, the transmitted signal is not exactly periodical so that a continuous spectrum is generated. The peak of the first harmonic is approximately at the frequency f₀=1/T_{bit}. T_{bit} represents the duration of information bits that are contained in one data packet.

The invention relates to an electronic system especially for vehicles. The electronic system comprises an electronic control unit, peripheral units and a communication line. The communication line connects the electronic control unit with the peripheral units. Digital data packets are exchanged between the control unit and the peripheral units via the communication line. The electronic system is configured so as to vary the duration of the data packets and/or the duration of the information bits contained in the appertaining data packet.

With the inventive method, it is ensured that the current between the peripheral units and the electronic control unit differs, to the extent possible, from a periodic function. For this purpose, the duration of the data packets and/or of the individual bits contained in the data packets is varied, for example, in discrete sequences. This leads to the frequency spectrum of the emitted electromagnetic radiation being distributed over a larger frequency range. The peak of the amplitude spectrum thus falls below the predetermined threshold value G, which is intended to be an acceptable limit for electromagnetic radiation.

Preferably, the data packets are multiplexed on the communication under control of a clock signal. The frequency of the clock-pulse generator is varied so that the amplitude spectrum is widened.

Components are typically associated with the peripheral units. Sensors, actors, belt retractor drives or igniters on pyrotechnical restraint systems can be such components. These components are each constituents of a restraint system for vehicle occupants. The electronic system according to the invention can also comprise other electrical vehicle components such as parts of the anti-blocking brake system or of the lighting system.

A preferred embodiment of the present invention is described below with reference to the accompanying figures. In the drawings:

FIG. 1 shows amplitude spectra of electromagnetic radiation with the conventional electronic system and with the electronic system according to the invention;

FIG. 2 is a schematic block diagram of the electronic system of the preferred embodiment;

FIG. 3 illustrates the transmission of a signal that is commonly exchanged in an electronic system between peripheral units and an electronic control unit;

FIG. 4 illustrates the transmission of a signal that is exchanged according to the invention in an electronic system between peripheral units and an electronic control unit; and

FIG. 5 illustrates the transmission of a data packet aₓ in which information bits T_{x,1}, . . . , T_{x,n} are contained.

FIG. 2 schematically shows the structure of the electronic system according to the invention. An electronic control unit 10a and two exemplary peripheral units 12b, 12c are depicted in the figure. The electronic control unit 10a and the peripheral units 12b, 12c are connected to each other via a communication line 20. The control unit 10a and the peripheral units 12b, 12c each include a multiplexer “X” for connection to the communication line 20. The multiplexers X are clocked by a clock signal provided by a clock generator CLK. Digital data packets are transmitted via the communication line between all of the connected electronic units. The peripheral units 12b, 12c may include sensors that are monitored by the electronic control unit 10a. In this case, the measured data of the sensors is transmitted to the control unit 10a.

FIG. 3 schematically shows the conventional form of the data exchange between the peripheral units 12b, 12c and the electronic control unit 10a. The reference letter a designates the length of the data packets that are transmitted. The amplitude of the signals is designated V. Conventionally, the length a of the data packets as well as the duration T_{bit} of the bits contained in the data packets are constant. Consequently, the transmission signal is essentially a periodical function whose period is marked with a T in FIG. 3. The emitted electromagnetic radiation has an amplitude peak at a frequency f₀=1/T_{bit}, as is shown in FIG. 1.

According to the invention, the length a of the data packets as well as the duration T_{bit} of the bits contained therein are varied, preferably in discrete steps. This is shown in FIGS. 4 and 5. The reference letters a₁ to aₘ each represent different discrete lengths of the data packets. The reference letters T_{x,1} to T_{x,n} each designate different discrete lengths of the information bits contained in the appertaining data packet aₓ. Due to the variation of the time parameters a and T_{bit}, the amplitude spectrum of the emitted electromagnetic radiation widens in such a way that the maximum amplitude lies below the threshold value G. Consequently, the electronic components are less interfered with by the radiation.

1. A method of exchanging digital data in discrete data packets between an electronic control unit and electronic peripheral units through a communication line, comprising at least one of the steps of:
varying the length in time of successively transmitted data packets; and
varying the length in time of information bits contained in a transmitted data packet.

2. The method according to claim 1, wherein the data packets are switched onto the communication line under control of a clock signal and the clock signal has a frequency that is varied in time.

3. The method according to claim 1, wherein the peripheral units comprise at least one of the following
a sensor,
an actor,
a belt retractor drive,
an igniter on a pyrotechnical restraint system.

4. An electronic system especially for vehicles, comprising
an electronic control unit (10a),
a plurality of peripheral units (12b, 12c), and
a communication line (20) that connects the electronic control unit (10a) with the peripheral units (12b, 12c);
at least said control unit being adapted to transmit digital data in discrete successive data packets over said communication line varying at least one of:
the length in time of successively transmitted data packets; and
the length in time of information bits contained in a transmitted data packet.

5. The electronic system according to claim 4, comprising a clock generator that provides a clock signal and multiplexer means, the data packets being multiplexed onto the communication line under control of the clock signal.

6. The electronic system according to claim 5, wherein the clock generator generates a clock signal of a variable frequency.

7. The electronic system according to claim 4, wherein the peripheral units (12b, 12c) have associated components selected from the group consisting of:
sensors,
actors,
belt retractor drives,
igniters on pyrotechnical restraint systems.

8. The electronic system according to claim 7, and comprising at least one sensor detecting acceleration of a vehicle body.
